(19) United States
(12) Patent Application Publication
(10) Pub. No.: US 2005/0288918 A1
(43) Pub. Date: Dec. 29, 2005

(54) System and method to facilitate simulation

(76) Inventors: Thomas W. Chen, Fort Collins, CO (US); Eugene Berta, Windsor, CO (US)

Correspondence Address: HEWLETT-PACKARD COMPANY;Intellectual Property Administration, P.O. BOX 272400, Fort Collins, CO, 80527-2400, US

(21) Appl. No.: 11/089,582

(22) Filed: Jun. 24, 2004

(51) Int. Cl. G06F 9/45

(52) U.S. Cl. 703/22

(57) ABSTRACT

One disclosed embodiment may comprise a system to facilitate simulation that includes a mapping system that converts parameter data having a first form corresponding to a first frequency distribution for at least one parameter to a second form, the second form corresponding to a modified frequency distribution for the at least one parameter that is functionally related to the first form and that exhibits an increased variation in the at least one parameter relative to the first form.

### BACKGROUND

Various types of testing and simulation are performed to ascertain the reliability of a system or a process. To be useful, the number of simulation runs should be sufficient to provide a desired level of confidence in the simulation results. For the example of certain types of integrated circuits and other systems, simulations are often run to determine reliability according to an approach, referred to as the corner method. In the corner method, all parameters are concurrently forced to their six-sigma value during the simulation. However, in many instances, the failure rates may be so low such that the number of requisite simulation runs in the corner method may become impractical to implement efficiently.

### SUMMARY

One embodiment of the present invention may comprise a system to facilitate simulation that includes a mapping system that converts parameter data having a first form corresponding to a first frequency distribution for at least one parameter to a second form, the second form corresponding to a modified frequency distribution for the at least one parameter that is functionally related to the first form and exhibiting an increased variation in the at least one parameter relative to the first form.

Another embodiment may comprise an apparatus for performing simulation of a system. The apparatus may include a converter that modifies original parameter data for at least one parameter of the system to a modified form of the parameter data that is functionally related to the original parameter data and that exhibits increased variation in the at least one parameter. A simulator performs a plurality of simulations on a model of the system which varies in the at least one parameter for each of the plurality of simulations by selecting the at least one parameter from the modified form of the parameter data. The simulator provides an indication of reliability for the system based on the modified form of the parameter data. A mapping system determines an actual indication of reliability for the system by mapping the indication of reliability provided by the simulator to the original parameter data.

Yet another embodiment may comprise an apparatus to facilitate simulation. The apparatus includes means for converting parameter data representing at least one parameter of a system from a first form of the parameter data to a second form of the parameter data, the second form of the parameter data being functionally related to the first form of the parameter data and exhibiting a wider distribution for the at least one parameter relative to the first form of the parameter data. The apparatus also may include means for performing simulations of the system based on the second form of the parameter data and for providing results for the simulations. The apparatus also may include means for mapping results of the simulations to the first form of the parameter data to provide a corresponding probability for at least one operating characteristic of the system.

Still another embodiment may comprise a method that includes converting a first functional form of parameter data representing at least one parameter of a system to a second functional form of the parameter data, the second functional form of the parameter data being functionally related to the first functional form and exhibiting increased variation in respect to the at least one parameter relative to the first functional form. The method also includes employing simulation results to determine an indication of reliability for the system, the simulation results resulting from simulations performed for the system based on the second functional form.

Another embodiment may comprise a computer readable medium having computer executable instructions for performing a method that includes converting a first frequency distribution for at least one parameter of a system to a second frequency distribution for the at least one parameter. The second frequency distribution is functionally related to the first frequency distribution and exhibits increased variation in respect to the at least one parameter relative to the first frequency distribution. Results of simulation performed with the second frequency distribution are mapped to a corresponding indication of reliability for the system associated with the first frequency distribution.

### BRIEF DESCRIPTION OF THE DRAWINGS

FIG. 1 depicts an embodiment of a system to facilitate simulation.

FIG. 2 depicts another embodiment of a system to facilitate simulation.

FIG. 3 is a graphical depiction of an embodiment that can be employed to facilitate simulation.

FIG. 4 is an example of a computer system that can be employed to implement an embodiment of a method to facilitate simulation.

FIG. 5 is flow diagram depicting an embodiment of a method.

FIG. 6 is a flow diagram depicting another embodiment of a method.

### DETAILED DESCRIPTION

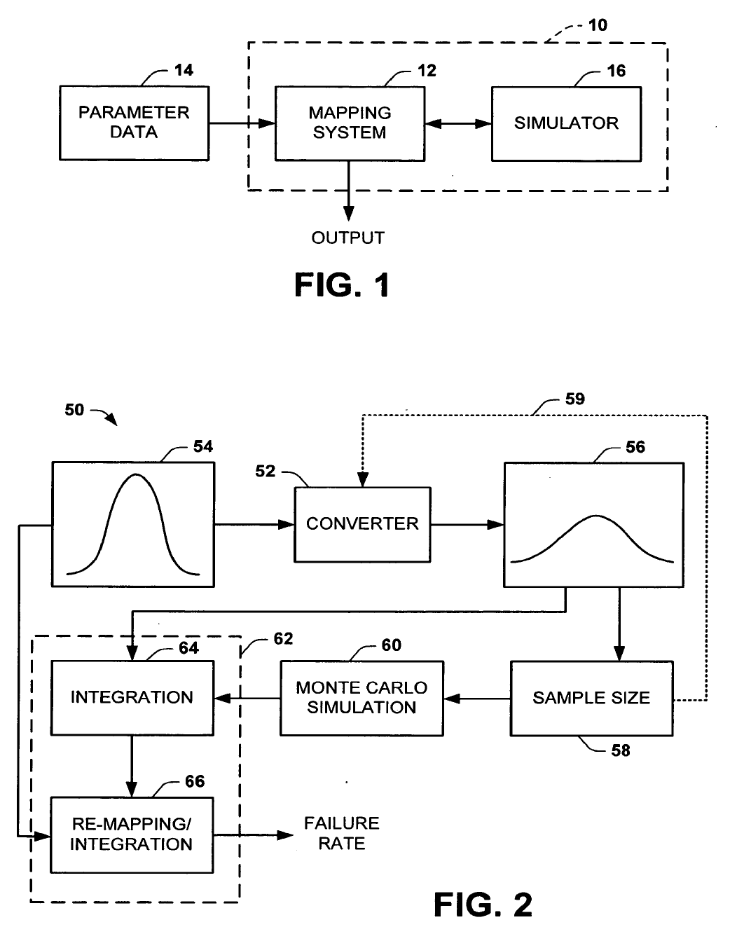

FIG. 1 depicts an example of a system (or apparatus) 10 that can be utilized to facilitate simulation of a real system, which can include a device, event or process. For example, the system 10 can be utilized to facilitate simulation of an integrated circuit or a portion thereof, such as one or more circuit components. The system 10 thus can be utilized to determine the reliability of one or more static random access memory (SRAM) cells or other parts of an integrated circuit. The system 10 is configured to provide an indication of the reliability in an efficient manner that requires fewer simulation runs than many existing systems. The efficiency of the approach employed by the system 10 becomes more efficacious for simulations implemented on extremely reliable systems (e.g., those having low failure rates), such as SRAM cells.

The system 10 includes a mapping system 12 that receives parameter data 14. The parameter data 14 can describe an operating characteristic, a physical characteristic or condition of a system or process for which simulation is desired. For the example of simulating an integrated circuit, such as a cell, parameters can represent channel length of transistors, width of transistors, threshold voltages, reference voltages, temperature as well as any other operating condition or physical characteristic associated with the integrated circuit or a component thereof. The parameter data 14 can be provided in the form of a frequency distribution for the respective parameter or parameters that describe one or more corresponding characteristics of the system. Alternatively, a corresponding frequency distribution can be generated from the parameter data 14. As an example, the parameter data 14 can be provided as a mean and standard deviation for each respective parameter, based on which a corresponding frequency distribution can be readily ascertained. The frequency distribution can be a single-variate distribution or a multi-variate distribution.

The mapping system 12 is programmed and/or configured to convert the parameter data 14 for one or more parameters to a modified form that is functionally related to the original parameter data and that exhibits an increase in parameter variation relative to the original parameter data. The modified form of the parameter data facilitates subsequent simulation with the data. A simulator 16 thus can employ the modified data by running a plurality of simulations on a model based on the modified form of data to ascertain a corresponding indication of reliability (e.g., a failure rate) for the modeled system or portions thereof. The model can be designed to simulate the real system or portion of the real system being analyzed. For instance, the modified parameter data can have the form of a frequency distribution that is wider than the original frequency distribution that represents the original parameter data 14. By way of further example, the mapping system 12 can be configured to multiply a normal distribution representing the parameter data 14 by a constant factor to provide a corresponding modified normal distribution for such data. The modified frequency distribution can be continuous or a discrete distribution and can be normalized to a value that is commensurate with the original distribution.

The simulator 16 performs the simulations based on the modified parameter data. The simulator 16 performs the simulations with respect to a model that has been programmed and/or configured to describe the system or event or a desired portion thereof. For example, computer automated engineering (CAE) tools exist to analyze and test operation according to a model that describes a given circuit design having specified circuit parameters under specified operating conditions. Such tools can be employed to ascertain a reliability of the circuit based on parameter data for the circuitry, which can be provided by the manufacturer. Those skilled in the art will understand and appreciate that any commercially available or proprietary circuit simulation tools, such as SPICE and other computer automated engineering (CAE) tools can be employed to implement such simulation. The simulator 16 can perform a plurality of simulation runs for one or more parameters (e.g., physical and operating parameters), which can be varied over the plurality simulation runs. For instance, the simulator 16 can randomly select the one or more parameters from the modified parameter data provided by the mapping system 12 for each simulation run. The simulator 16 provides results indicative of reliability (e.g., a failure rate).

Those skilled in the art will understand and appreciate that significantly fewer simulation runs may be needed with the system 10 in order to ascertain an adequate indication of reliability than with many existing approaches. The simulator 16 can be configured to perform a fixed number of simulations. The simulator 16 can perform a number of simulation runs that is functionally related to the modified parameter data and a desired confidence level for the simulations results. Thus, for the example of an integrated circuit, the simulator 16 can provide an indication of reliability (e.g., a rate of failure) for the integrated circuit according to the modified parameter data.

The mapping system 12 further is programmed and/or configured to provide a corresponding indication of reliability for the original parameter data 14 based on the indication of reliability determined for the modified parameter data. That is, the mapping system 12 maps the indication of reliability (e.g., the failure rate) provided by the simulator 16 back to the original parameter data. For example, the mapping system 12 employs numerical methods (e.g., including integration) to map the resulting failure probability associated with the modified parameter data back to the original parameter data 14 to provide a corresponding actual failure probability associated with the original parameter data 14.

By way of further example, assuming that a typical failure rate of a cell or other set of one or more components is approximately 0.1 parts per million, a traditional simulation performed on the original parameter data 14 might require more than 10 million simulation runs to observe a single failure event. With the approach described herein, a sufficient number of failure events can be observed with significantly fewer simulation runs and achieve a non-negligible probability of failure. As described herein, the total number of simulation runs (the sample size) needed to obtain an adequate failure rate for a given confidence level can be predetermined as a function of the required confidence level and an estimate of the actual failure rate. The estimated failure rate may be provided based on past experience with related systems.

FIG. 2 depicts another example of a system 50 that can be utilized to facilitate simulation. The system 50 includes a converter 52 that transforms original parameter data 54 for one or more parameters of a system or process into modified parameter data such as including a frequency distribution 56. For purposes of simplicity of explanation, the example of FIG. 2 will be described with respect to simulation of an integrated circuit or a portion thereof, such as one or more SRAM cells or other circuitry (e.g., utilized to construct caches in microprocessor chips). For example, a typical SRAM cell includes a plurality of transistors, with the basic building block being a cross-coupled inverter pair. While fabrication of SRAM cells is a relatively well developed technology, variations in deep submicron CMOS technology may cause a SRAM cell design based on one process corner to malfunction at another process corner. Accordingly, stability and reliability of SRAM cells are still important considerations in the design of microprocessors.

The original parameter data 54 can correspond to original fabrication data (e.g., provided by a manufacturer) associated with one or more parameters. The original fabrication data, for example, can be provided in terms of a mean value and a corresponding standard deviation for each parameter, based on which a corresponding probability distribution function can be generated. For purposes of analyzing reliability of circuitry of an integrated circuit, such as SRAM cells, a normal probability distribution (e.g., a Gaussian-type distribution) can be employed. The normal probability distribution is symmetric about its mean, and by normalization over all real numbers, the distribution can be implemented to represent the parameters being evaluated.

The converter 52 thus is operative to modify an original frequency distribution associated with the original parameter data 54 to a second form that is functionally related to the original frequency distribution and exhibits increased variation in the one or more parameters represented in the original frequency distribution. For instance, the converter 52 can be configured to modify the frequency distribution associated with the original parameter data 54 to a widened frequency distribution. The resulting widened distribution effectively causes the parameter variations to appear worsened relative to the original fabrication data. Since the original frequency distribution for the original parameter data 54 is a substantially normal distribution, the new widened distribution 56 can also be provided by the converter 52 as a normalized distribution.

Those skilled in the art will appreciate that the original and widened distributions 54 and 56 can have many forms. The particular form of distribution can vary, for example, based on the type of simulation being performed and the parameters being modeled by simulation. Regardless, the particular type of distribution should realistically describe each parameter in the model. Additionally, the original and modified distributions can also be normalized to a consistent value (e.g., both normalized to a value of one) over an appropriate domain to ensure accuracy for the simulation.

By way of further example, the converter 52 can spread the parameter distribution 54 by multiplying the original distribution by a spread factor a prior to implementing simulations on such data. For instance, let the original normal distribution be expressed as a function of mean μ₁ and standard deviation σ₁, as follows:
N=N(μ₁,σ₁²), EQ. 1
and the new widened distribution can be expressed as:
N=N(μ₂,σ₂²). EQ. 2
Further, as mentioned above, α is the spread factor that is applied to the original distribution 54 to generate the widened parameter frequency distribution 56. Accordingly, by applying the spread factor to the original distribution, the standard deviation of the widened normalized distribution can be expressed as:
σ₂=α×σ₁. EQ. 3
Accordingly, if a failure is detected at a parameter value P in the widened distribution:
P=β×σ₂, EQ. 4
then, this failure also occurs at:
P=β×σ₂=β×α×σ₁. EQ. 5

In order to widen the distribution 54, the spread factor a can be any positive real number greater than one (e.g., α>1). Different values of the spread factor can be utilized for different parameters, such as when the original frequency distribution 54 comprises a multivariate distribution or when the system 50 is utilized for independent simulations on respective parameters. Independence of parameters can be assumed and separate simulations can be implemented, for example, when performing simulations with respect to an integrated circuit or a portion thereof (e.g., an SRAM cell). Those skilled in the art will appreciate that the spread factor α can be a multiplying constant, although other functional forms (e.g., linear, piecewise-linear, variable, etc.) could also be utilized.

A sample size function 58 can be applied to the widened distribution 56 to determine a sample size representing the number of simulation runs required to achieve a given confidence level and estimated percent of reliability for the integrated circuit. As an example, a relationship between sample size and the confidence level can be express as:

$$sample size = \frac{{Z}^{2} \times p \times ( 1 - p )}{{c}^{2}} \qquad EQ . 6$$

where Z is the Z-value, which is a critical value that can be obtained from a standard normal table (see, e.g., Table I below),

p is an estimated percentage of failure (expressed as a decimal), and

c is the desired confidence interval (also expressed in decimal).

The Z-value represents the ±σ values where the area under the normal distribution curve and between the ±σ or equals to some pre-defined value. This area represents the probability a test (e.g., an outcome of a simulation) will fall under. Therefore, as represented in Table I, the Z-value is functionally related to the required confidence level.

TABLE I

| CONFIDENCE LEVEL | Z-VALUE |
|---|---|
| 90% | 1.645 |
| 95% | 1.96 |
| 96% | 2.04 |
| 97% | 2.175 |
| 98% | 2.326 |
| 99% | 2.576 |
| 99.9% | 3.3 |
| 99.99% | 3.9 |
| 99.999% | 4.4 |

By way of comparison, the sample size function 58 (e.g. from EQ. 6) can be applied to the original distribution 54. Whereas the requisite sample size for simulation with the original distribution 54 (e.g., for an SRAM cell) may require tens or hundreds of millions of simulations to obtain a non-negligible indication of reliability, the sample size for the spread (or widened) distribution 56 typically may be in the tens of thousands (e.g., for a spread factor in the range 2≦α≦3 ). Thus, as represented by a dashed line 59, the converter 52 can be adaptively modified based on the results of the sample size function 58, as needed. For instance, the converter 52 can be modified to utilize a spread factor a selected to provide a reasonable sample size for a desired confidence level for each parameter.

A monte carlo simulation component 60 performs simulation for the number of simulation runs determined by the sample size function 58. The monte carlo simulation component 60 performs simulation for one or more parameters based on the widened distribution 56 generated for the one or more parameters. The monte carlo simulation component 60 is programmed as a metric to describe the real system being modeled. For the example of simulating an integrated circuit or a portion thereof (e.g., an SRAM cell), such as corresponding to a group of interconnected transistors, SPICE software can be utilized in the simulations to define the metric that describes such circuitry. The monte carlo simulation component 60 is programmed to randomly select values of parameters along the widened distribution 56 and provide a value indicative of reliability (e.g., a failure rate) for the widened frequency distribution 56 based on the simulation results for the metric.

Since multiplying a normal distribution by a constant factor also results in a normal distribution, the system 50 further includes another mapping system 62 that maps the resultant indication of reliability provided by the monte carlo simulation component 60 with respect to the widened distribution 56 back to the original distribution 54. The mapping system 62 includes an integration function 64 as well as a re-mapping/integration component 66.

The integration function 64 can be employed to ascertain a sigma value for the widened frequency distribution 56. The sigma value corresponds to a value on the abscissa of the widened distribution 56 associated with the indication of reliability (a reliability value) determined by the monte carlo simulation component. For example, the integration function 64 can implement a cumulative distribution function (CDF) (e.g., integrating from negative infinity to the reliability value) for the one or more input parameters used by the metric (e.g., SPICE). The integration function 64 thus provides the sigma value based on which a corresponding probability can be determined for the original distribution.

The integration component 64 provides the results of the integration, including the sigma value, to the re-mapping/integration component 66. The re-mapping/integration component 66 is programmed to ascertain a failure rate (e.g., failure probability) under the original distribution based on the sigma value. The re-mapping/integration component 66 further can implement integration under the original distribution (e.g., from negative infinity to the sigma value) and, in turn, provide an indication of the reliability of the system simulated by the monte carlo simulation 60 in the context of the original distribution 54. For example, the indication of reliability can be provided as a decimal or percentage (e.g., a failure rate) for the one or more parameters represented in the distribution 54.

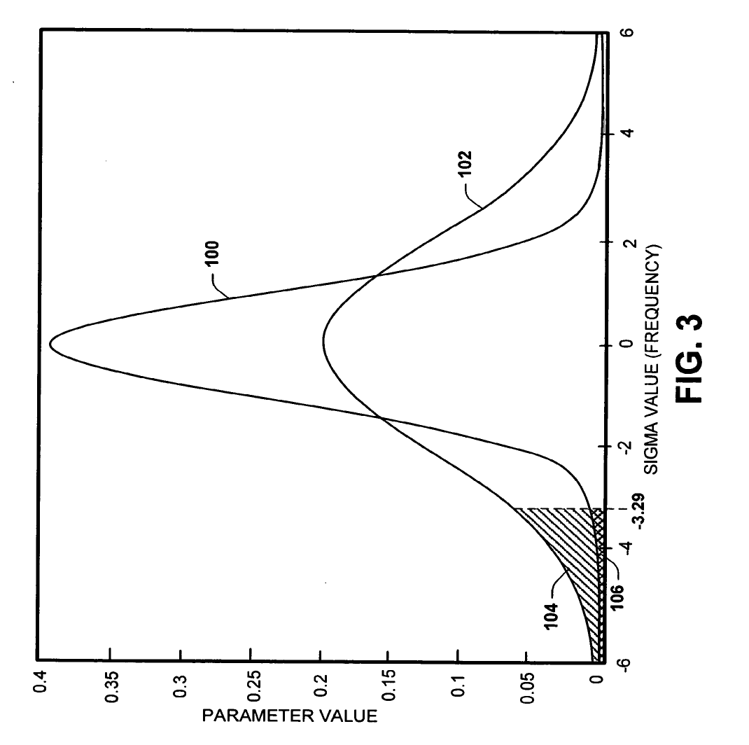

The mapping, such as performed by the mapping system 62 of FIG. 2, will be better appreciated with respect to the graphs depicted in FIG. 3. FIG. 3 depicts an original frequency distribution 100, as well as a widened frequency distribution 102. For purposes of this example, it is assumed that the frequency distributions 100 and 102 have been normalized such that the areas under the distributions are substantially equal (e.g., equal to 1). The distributions 100 and 102 may be discrete or continuous distributions.

By way of example, assume that the frequency distribution associated with original fabrication data is spread by multiplying the distribution by a constant spread factor (e.g., α=2) and assume that the simulation results in providing a 10% failure rate for such conditions associated with the widened distribution 102. It is to be appreciated that such a constant spread factor α=2 corresponds to a 2-sigma curve. Assuming that the 10% failure rate corresponds to both sides of the Gaussian distribution, the “sigma” value of interest (the x axis location) of the distribution that occupies 5% of the curve.

The integration function for the portion of the shaded area of the curve, indicated at 104, corresponds to the cumulative distribution function from negative infinity until 0.05 (5%). Those skilled in the art will understand various implementations of the cumulative distribution function that can be utilized to integrate the shaded area 104 and obtain a corresponding sigma value, which in this example is approximately −3.29. Since the −3.29 corresponds to the sigma value from simulation for the widened distribution, the value of interest is the corresponding failure rate in the original distribution 100 from negative infinity up to the −3.29 sigma value. Accordingly, the original (non-skewed) distribution 100 can be integrated from negative infinity up to the −3.29 to obtain corresponding failure rate associated with the shaded area under the original frequency distribution 100, which shaded area is indicated at 106. Since the area 106 corresponds to half the failure rate of the distribution 100, the failure rate value can be multiplied by 2 to obtain a corresponding failure probability under the complete original distribution, namely approximately 0.1003%. While the foregoing example was shown and described for a uni-variate frequency distribution representing one parameter, those skilled in the art will understand and appreciate that the approach described herein can be applied to multivariate frequency distributions based on the teachings herein.

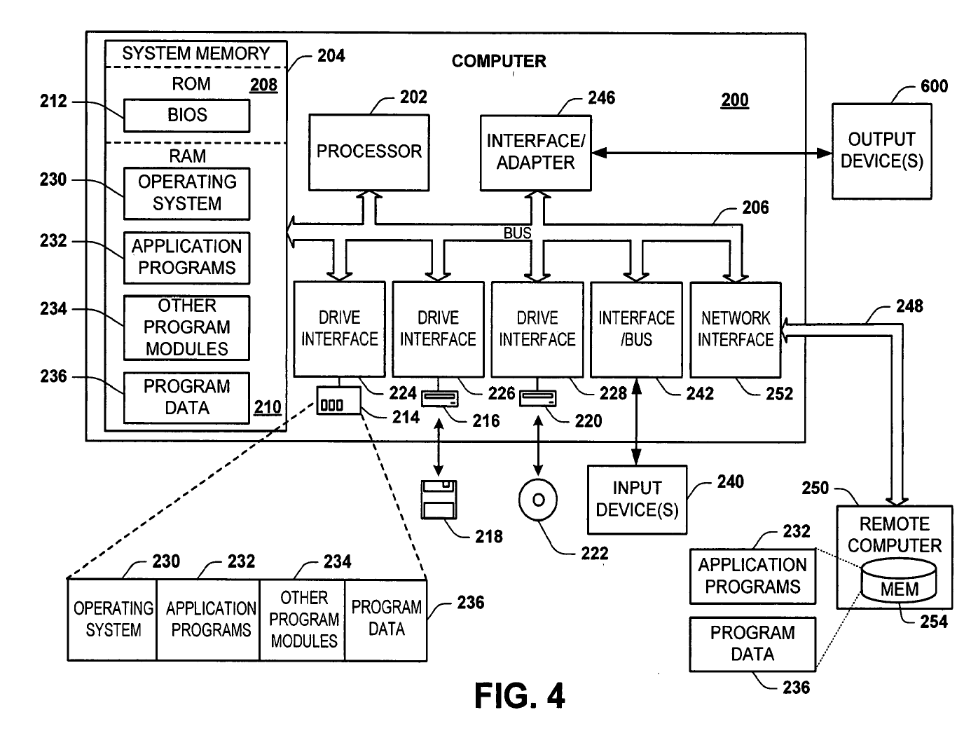

FIG. 4 illustrates a computer system 200 that can be employed to implement systems and methods described herein, such as based on computer executable instructions running on the computer system. The computer system 200 can be implemented on one or more general purpose networked computer systems, embedded computer systems, routers, switches, server devices, client devices, various intermediate devices/nodes and/or stand alone computer systems. Additionally, the computer system 200 can be implemented as part of the computer-aided engineering (CAE) tool running computer executable instructions to perform a method as described herein.

The computer system 200 includes a processor 202 and a system memory 204. A system bus 206 couples various system components, including the system memory 204 to the processor 202. Dual microprocessors and other multi-processor architectures can also be utilized as the processor 202. The system bus 206 can be implemented as any of several types of bus structures, including a memory bus or memory controller, a peripheral bus, and a local bus using any of a variety of bus architectures. The system memory 204 includes read only memory (ROM) 208 and random access memory (RAM) 210. A basic input/output system (BIOS) 212 can reside in the ROM 208, generally containing the basic routines that help to transfer information between elements within the computer system 200, such as a reset or power-up.

The computer system 200 can include a hard disk drive 214, a magnetic disk drive 216, e.g., to read from or write to a removable disk 218, and an optical disk drive 220, e.g., for reading a CD-ROM or DVD disk 222 or to read from or write to other optical media. The hard disk drive 214, magnetic disk drive 216, and optical disk drive 220 are connected to the system bus 206 by a hard disk drive interface 224; a magnetic disk drive interface 226, and an optical drive interface 234, respectively. The drives and their associated computer-readable media provide nonvolatile storage of data, data structures, and computer-executable instructions for the computer system 200. Although the description of computer-readable media above refers to a hard disk, a removable magnetic disk and a CD, other types of media which are readable by a computer, may also be used. For example, computer executable instructions for implementing systems and methods described herein may also be stored in magnetic cassettes, flash memory cards, digital video disks and the like.

A number of program modules may also be stored in one or more of the drives as well as in the RAM 210, including an operating system 230, one or more application programs 232, other program modules 234, and program data 236. For example, the application programs 232 can include executable instructions programmed to facilitate simulation, which further can be implemented as part of a CAE tool. Thus, as part of a design process for an integrated circuit, a circuit analysis tool (e.g., SPICE) can implement a function call to appropriate instructions to modify parameter data (e.g., a frequency distribution function for one or more parameters) prior to running the analysis, such as described herein. The parameter data can be stored as the program data 236 or, alternatively, as part of an application program 232. By running the circuit analysis or simulations based on the modified parameter data, the number of simulation runs can be significantly reduced. The application programs 232 further contains code operative to map the simulation results back to the original distribution after the simulation runs have been performed with the modified parameter data.

A user may enter commands and information into the computer system 200 through user input device 240, such as a keyboard, a pointing device (e.g., a mouse). Other input devices may include a microphone, a joystick, a game pad, a scanner, a touch screen, or the like. These and other input devices are often connected to the processor 202 through a corresponding interface or bus 242 that is coupled to the system bus 206. Such input devices can alternatively be connected to the system bus 206 by other interfaces, such as a parallel port, a serial port or a universal serial bus (USB). One or more out device(s) 244, such as a visual display device or printer, can also be connected to the system bus 206 via an interface or adapter 246.

The computer system 200 may operate in a networked environment using logical connections 248 to one or more remote computers 250. The remote computer 248 may be a workstation, a computer system, a router, a peer device or other common network node, and typically includes many or all of the elements described relative to the computer system 200. The logical connections 248 can include a local area network (LAN) and a wide area network (WAN).

When used in a LAN networking environment, the computer system 200 can be connected to a local network through a network interface 252. When used in a WAN networking environment, the computer system 200 can include a modem (not shown), or can be connected to a communications server via a LAN. In a networked environment, application programs 232 and program data 236 depicted relative to the computer system 200, or portions thereof, may be stored in memory 254 of the remote computer 250.

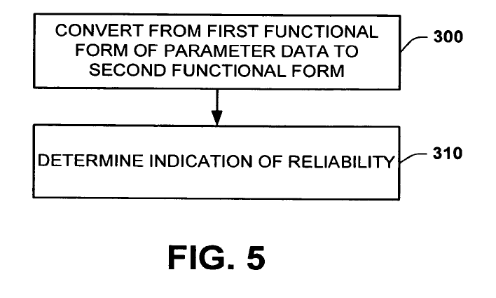

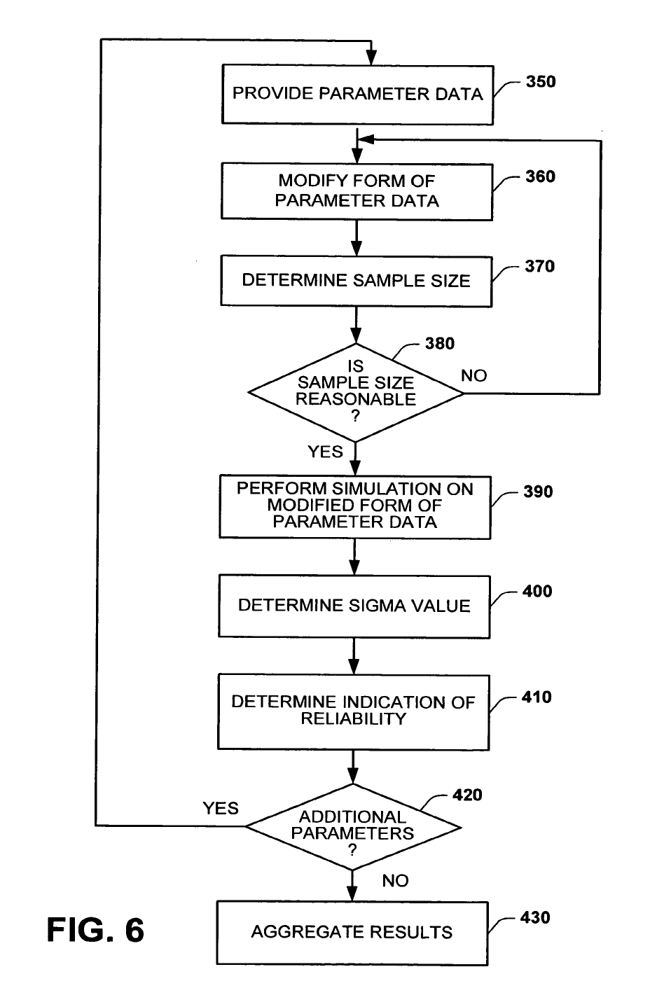

In view of the foregoing structural and functional features described above, certain methods will be better appreciated with reference to FIGS. 5 and 6. It is to be understood and appreciated that the illustrated actions, in other embodiments, may occur in different orders and/or concurrently with other actions. Moreover, not all illustrated features may be required to implement a method. It is to be further understood that the following methodologies can be implemented in hardware (e.g., a computer or a computer network), software (e.g., as executable instructions running on one or more computer systems), or any combination of hardware and software.

FIG. 5 depicts a method. The method may include converting a first functional form of parameter data representing at least one parameter of a system to a second functional form of the parameter data, the second functional form of the parameter data being functionally related to the first functional form and exhibiting increased variation in respect to the at least one parameter relative to the first functional form, as shown at 300. The method may also include employing simulation results to determine an indication of reliability for the system, the simulation results resulting from simulations performed for the system based on the second functional form, as shown at 310.

FIG. 6 depicts an example of a method that can be utilized to facilitate simulation. The method begins at 350, in which an original parameter distribution is provided. The original distribution can be generated for one or more parameters that describe operating or physical characteristics associated with a system, such as integrated circuit or a portion thereof. As an example, the method can be implemented relative to one or more SRAM cells, which typically consists of a plurality of interconnected transistors. It is to be appreciated that the approach described herein can be implemented relative to other types of circuit components as well as to other systems. The original parameter distribution can also be normalized, such that the area under the distribution is equal to one, for example. It should be noted that the distribution could be a continuous or a discrete distribution.

At 360, the original distribution is modified to a different form. For instance, the original distribution can be multiplied by a spread factor to widen the distribution and maintain normalization of the modified distribution. The spread factor can be a positive number greater than one, or it can be a variable or other function that that is applied to modify the original distribution to a form that facilitates simulation, as described herein. After the original distribution has been modified, the method proceeds to 370.

At 370, a sample size for purposes of simulation is determined. The sample size corresponds to the number of simulation runs needed to achieve a desired confidence interval. At 380, a determination is made as to whether the sample size determined at 370 is reasonable. For instance, the sample size might be compared to a threshold to ascertain whether the number of simulation runs necessary to achieve the desired confidence level for the modified distribution is too large. If the sample size is not reasonable (NO), the method returns to 360 in which the original distribution can be modified a different amount than previously modified (e.g., employing a different spread factor) and the sample size can be reevaluated at 370. If the sample size is reasonable (YES), the method proceeds to 390.

At 390, simulation on the system is performed with respect to the modified distribution. The simulation, for example, can be implemented as monte carlo simulation that has been programmed to model a real system (e.g., an SRAM cell). The simulation is performed to obtain a corresponding failure rate or probability based on the modified parameter distribution. The simulation can be implemented for a predetermined number of simulation runs, as defined by the sample size (370).

At 400, a sigma value for the modified distribution is determined based on results of the simulation. For example, the sigma value can be determined as a cumulative distribution function that is implemented according to the failure rate determined by the simulation implemented (at 390) for the modified distribution. The corresponding sigma value determined at 400 from the modified distribution is utilized to determine a corresponding failure rate for the original distribution. For example, the original frequency distribution can be integrated from negative infinity up to the sigma value corresponding to the failure rate of the modified distribution to provide a corresponding failure probability under the original parameter distribution.

At 420, a determination is made as to whether there are any additional parameters that are to be evaluated using the corresponding simulation. If additional parameters exist, the methodology returns to 350 to implement the foregoing method with respect to the additional parameter. It is to be understood and appreciated that the foregoing approach assumes that the parameters in each original distribution are statistically independent. However, those skilled in the art will understand and appreciate that statistical dependencies between parameters can be taken into account and a corresponding multi-various approach utilized for determining the failure rate associated with the multi-variant distribution. After all parameters have been utilized to obtain corresponding failure rates, from 420, the methodology proceeds to 430.

At 430, the results (e.g., failure rates) for the parameters being evaluated by the method can be aggregated. The aggregation may consider interrelationships among the respective parameters to obtain a corresponding indication of the reliability of the system being modeled. From the foregoing, those skilled in the art will further appreciate that the spread factor implemented with respect to the respective parameters can be the same or different. For instance, different spread factors can be applied to different parameters to implement adaptive simulation events, which can be adjusted depending on the original frequency distributions. When different parameter distributions are skewed differently by applying different spread factors, different corresponding functions can be employed to obtain respective probabilities.

Furthermore, different sample sizes can be employed for different parameters, which can be selected by specifying different confidence levels or when different types of parameter modifications are implemented at 360 for the respective parameters. In this way, the approach can be fully adaptable and flexible to provide for a more realistic likelihood of failure with respect to the distance to the nominal parameter values. For example, in the case of reliability analysis for circuit components, a failure probability can be obtained in terms of parts per millions.

What has been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

1. A system to facilitate simulation comprising:
a mapping system that converts parameter data having a first form corresponding to a first frequency distribution for at least one parameter to a second form, the second form corresponding to a modified frequency distribution for the at least one parameter that is functionally related to the first form and exhibiting an increased variation in the at least one parameter relative to the first form.

2. The system of claim 1, wherein the mapping system applies a spread factor to the first frequency distribution to provide the modified frequency distribution as a widened frequency distribution.

3. The system of claim 2, wherein the spread factor comprises a constant, the mapping system multiplying a standard deviation of the first frequency distribution by the spread factor to produce the widened frequency distribution.

4. The system of claim 2, wherein the first frequency distribution and the modified frequency distribution comprise respective normalized frequency distributions.

5. The system of claim 1, further comprising a simulator that employs the modified frequency distribution to provide at least one value indicative of an operating characteristic of a real system based on results of a number of simulations performed on a model of the real system according to the least one parameter selected from the modified frequency distribution.

6. The system of claim 5, wherein the simulator comprises a monte carlo simulation component.

7. The system of claim 5, wherein the operating characteristic comprises an indication of reliability for the real system.

8. The system of claim 5, wherein the real system comprises at least a portion of an integrated circuit, and the simulator employing the modified frequency distribution to provide an indication of reliability for the at least a portion of the integrated circuit.

9. The system of claim 8, wherein the at least a portion of the integrated circuit further comprises at least one static random access memory (SRAM) cell.

10. The system of claim 5, further comprising a sample size function that determines the number of simulations to be performed on the model to achieve a given confidence level.

11. The system of claim 1, wherein the mapping system is a first mapping system, the system further comprising a second mapping system that converts simulation results derived from simulation performed based on the modified distribution to a corresponding indication of reliability associated with the first frequency distribution.

12. The system of claim 11, wherein the second mapping system further comprises:
an integration function that integrates a portion of the modified frequency distribution to provide a sigma value based on the simulation results; and
a re-mapping component that employs the sigma value relative to the first frequency distribution to determine a probability under the first frequency distribution.

13. An apparatus for performing simulation of a system, comprising
a converter that modifies original parameter data for at least one parameter of the system to a modified form of the parameter data that is functionally related to the original parameter data and that exhibits increased variation in the at least one parameter;
a simulator that performs a plurality of simulations on a model of the system which varies in the at least one parameter for each of the plurality of simulations by selecting the at least one parameter from the modified form of the parameter data, the simulator providing an indication of reliability for the system based on the modified form of the parameter data; and
a mapping system that determines an actual indication of reliability for the system by mapping the indication of reliability provided by the simulator to the original parameter data.

14. The apparatus of claim 13, wherein the converter applies a spread factor to the original parameter data to provide the modified parameter data.

15. The apparatus of claim 14, wherein the original parameter data comprises a first normalized frequency distribution for the least one parameter, the converter applying the spread factor to the first normalized frequency distribution to provide the modified form of parameter data as a second normalized frequency distribution.

16. The apparatus of claim 15, wherein the spread factor comprises a constant value, the converter multiplying a standard deviation of the first normalized frequency distribution by the spread factor to provide the second normalized frequency distribution.

17. The apparatus of claim 15, wherein the mapping system further comprises:
an integration function that integrates a portion of the second normalized frequency distribution to provide a corresponding sigma value based on the indication of reliability of the system provided by the simulator; and
a re-mapping component that employs the sigma value relative to the first normalized frequency distribution to provide a probability of reliability for the system.

18. The apparatus of claim 13, wherein the simulator performs monte carlo simulation on the model of the system to determine the indication of reliability for the system in terms of the modified form of the parameter data.

19. The apparatus of claim 13, wherein the system comprises at least a portion of an integrated circuit.

20. The apparatus of claim 19, wherein the at least a portion of the integrated circuit further comprises at least one static random access memory (SRAM) cell.

21. The apparatus of claim 13, further comprising a sample size function that determines a number of the plurality of simulations to perform on the model with the modified form of parameter data sufficient to achieve a given confidence level.

22. An apparatus to facilitate simulation comprising:
means for converting parameter data representing at least one parameter of a system from a first form of the parameter data to a second form of the parameter data, the second form of the parameter data being functionally related to the first form of the parameter data and exhibiting a wider distribution for the at least one parameter relative to the first form of the parameter data;
means for performing simulations of the system based on the second form of the parameter data and for providing results for the simulations; and
means for mapping results of the simulations to the first form of the parameter data to provide a corresponding probability for at least one operating characteristic of the system.

23. The apparatus of claim 22, further comprising means for determining a number of simulations to be performed by the means for performing simulations.

24. The apparatus of claim 22, wherein the first form of the parameter data and the second form of the parameter data are corresponding normalized frequency distributions for the at least one parameter of the system.

25. The apparatus of the claim 24, wherein the system is at least a portion of an integrated circuit.

26. The apparatus of claim 25, wherein the corresponding probability comprises a probability of failure for the at least a portion of the integrated circuit.

27. A method comprising:
converting a first functional form of parameter data representing at least one parameter of a system to a second functional form of the parameter data, the second functional form of the parameter data being functionally related to the first functional form and exhibiting increased variation in respect to the at least one parameter relative to the first functional form; and
employing simulation results to determine an indication of reliability for the system, the simulation results resulting from simulations performed for the system based on the second functional form.

28. The method of claim 27, further comprising performing a plurality of the simulations on a model of the system based on substantially randomly selecting the at least one parameter from the second functional form.

29. The method of claim 27, further comprising determining a sample size for the simulations sufficient to achieve a given confidence level for the indication of reliability for the system.

29. The method of claim 27, wherein each of the first functional form and the second functional form comprises a first frequency distribution and a second frequency distribution for the at least one parameter, the method further comprising:
integrating a portion of the second frequency distribution to provide a corresponding sigma value based on the simulation results; and
determining the indication of reliability for the system as a probability value associated with the first frequency distribution based on the sigma value.

30. The method of claim 29, wherein the system comprises at least a portion of an integrated circuit, and the indication of reliability for the system comprising a failure probability for the at least a portion of the integrated circuit with respect to the at least one parameter.

31. The method of claim 27, wherein the converting further comprising applying a spread factor to the first functional form of the parameter data so that the second functional form of parameter data has a wider distribution relative to the first functional form of the parameter data.

32. The method of claim 27, further comprising aggregating the indication of reliability for the system for a plurality of parameters.

33. A computer programmed to perform the method of claim 27.

34. A computer readable medium having computer executable instructions for performing a method comprising:
converting a first frequency distribution for at least one parameter of a system to a second frequency distribution for the at least one parameter, the second frequency distribution being functionally related to the first frequency distribution and exhibiting increased variation in respect to the at least one parameter relative to the first frequency distribution; and
mapping results of simulation performed with the second frequency distribution to a corresponding indication of reliability for the system associated with the first frequency distribution.
